(19) United States
(12) Patent Application Publication
(10) Pub. No.: US 2015/0312858 A1
(43) Pub. Date: Oct. 29, 2015

(54) METHOD AND APPARATUS FOR GENERATING A BLUETOOTH LOW ENERGY DATA PACKET COMPRISING AUDIO PAYLOAD DATA

(71) Applicant: NOKIA CORPORATION OY, Espoo (FI)

(72) Inventor: Kanji KERAI, London (GB)

(21) Appl. No.: 14/443,563

(22) PCT Filed: Nov. 19, 2012
(86) PCT No.: PCT/IB2012/056548

§ 371 Date: May 18, 2015

(51) Int. Cl. H04W 52/02; H04W 4/00; H04L 1/00; H04L 29/06

(52) U.S. Cl. CPC H04W 52/0229; H04L 65/607; H04W 4/008; H04L 1/0061

(57) ABSTRACT

An apparatus comprising at least one processor and at least one memory including computer program code, the at least one memory and the computer program code configured to, with the at least one processor, enable the apparatus at least to generate a Bluetooth™ Low Energy data packet comprising audio payload data.

### TECHNICAL FIELD

The present disclosure relates to the field of Bluetooth™ Low Energy (BLE) Technology, associated methods and apparatus, and in particular concerns a BLE data packet comprising audio payload data. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

In order to transfer data from one electronic device to another, a communications channel must be established between the devices concerned. This may be achieved using a variety of different technologies. Whilst physical cables were traditionally used to link devices together, wireless connections are becoming increasingly common. Bluetooth™ is one such technology.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus comprising at least one processor and at least one memory including computer program code, the at least one memory and the computer program code configured to, with the at least one processor, enable the apparatus at least to generate a Bluetooth™ Low Energy data packet comprising audio payload data.

The apparatus may be configured to generate the data packet to include Cyclic Redundancy Check data for the audio payload data to enable the audio payload data to be checked for transmission errors.

The apparatus may be configured to generate the data packet to include an indication of a codec required for playback of the audio payload data and/or audio settings for controlling playback of the audio payload data. The audio settings may comprise volume settings.

The apparatus may be configured to modulate the Bluetooth™ Low Energy data packet onto a Bluetooth™ Low Energy channel to generate a transmission signal. The Bluetooth™ Low Energy channel may be one or more of a Bluetooth™ Low Energy advertising channel and a Bluetooth™ Low Energy data channel.

The apparatus may be configured to generate the data packet to include one or more of Bluetooth™ discovery information, Bluetooth™ connection establishment information and Bluetooth™ synchronization data for transmission via the Bluetooth™ Low Energy advertising channel.

The apparatus may be configured to generate a plurality of data packets with respective audio payload data for sequential portions of an audio stream for transmission via respective Bluetooth™ Low Energy advertising and/or data channels. The apparatus may be configured to generate respective Bluetooth™ Low Energy data packets with payload audio data of a particular size such that the non-receipt of the payload data of a particular packet for the audio stream can be concealed without substantial detriment to the user perception of the audio content for the audio stream.

The apparatus may be configured to generate a plurality of data packets with respective audio payload data for sequential portions of an audio stream for transmission via respective Bluetooth™ Low Energy data channels at a transmission burst interval of 10 ms. The apparatus is configured to generate a plurality of data packets with respective audio payload data for sequential portions of an audio stream for transmission via respective Bluetooth™ Low Energy advertising channels at a transmission burst interval of 1 s.

The apparatus may be configured to generate a plurality of data packets with respective audio payload data for sequential portions of an audio stream for hopping transmission via respective sequential Bluetooth™ Low Energy advertising and/or data channel bursts.

The apparatus may be configured to generate the data packets to include an indication of the start of the audio stream, the end of the audio stream and/or the order of the sequential portions of the audio stream.

The data packet may comprise no more than 376 bits. The payload audio data may comprise no more than 39 bytes. The apparatus may be configured to transmit the data packet at a data rate of up to 300 kbps.

The apparatus may be configured to generate a single non-repeated Bluetooth™ Low Energy data packet for particular audio payload data.

The apparatus may be one or more of an electronic device/apparatus (e.g. including a network element such as an access point or server), a portable electronic device, a portable telecommunications device and a module for any of the aforementioned devices.

According to a further aspect, there is provided an apparatus comprising at least one processor and at least one memory including computer program code, the at least one memory and the computer program code configured to, with the at least one processor, enable the apparatus at least to decode a received Bluetooth™ Low Energy data packet comprising audio payload data for audio output.

The apparatus may be configured to demodulate the data packet from a Bluetooth™ Low Energy channel before decoding the data packet. The apparatus may be configured to output the decoded audio output.

The apparatus may be configured to decode a plurality of Bluetooth™ Low Energy data packets comprising respective audio payload data for sequential portions of an audio stream received via respective Bluetooth™ Low Energy advertising and/or data channels for audio output as a corresponding output audio stream.

The apparatus may be one or more of a battery-powered device, an earpiece, a headset, a hearing aid and a module for one or more of the same.

According to a further aspect, there is provided a system comprising any apparatus described herein which is configured to generate a Bluetooth™ Low Energy data packet comprising audio payload data, and any apparatus described herein which is configured to decode a received Bluetooth™ Low Energy data packet comprising audio payload data for audio output.

The system may be configured to at least one of not require/accept acknowledgement of receipt of data packets from a receiver and not retransmit the same audio payload data in subsequent data packets.

According to a further aspect, there is provided a method comprising generating a Bluetooth™ Low Energy data packet comprising audio payload data.

The method may comprise modulating the Bluetooth™ Low Energy data packet onto a Bluetooth™ Low Energy channel to generate a transmission signal.

According to a further aspect, there is provided a method comprising decoding a Bluetooth™ Low Energy data packet comprising audio data for audio output.

The method may comprise demodulating the data packet from a Bluetooth™ Low Energy channel.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

According to a further aspect, there is provided a Bluetooth™ Low Energy data packet comprising audio payload data.

According to a further aspect, there is provided a transmission signal comprising a Bluetooth™ Low Energy data packet containing audio payload data.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1a shows the periodic transmission of BLE advertising channel packets by an advertising device;

FIG. 1b shows the transmission of a connection request from a scanning/initiating device to the advertising device;

FIG. 1c shows the establishment of a BLE connection between the advertising device and the scanning/initiating device;

FIG. 1d shows the transmission of synchronisation data from the scanning/initiating device to the advertising device via a BLE advertising channel;

FIG. 1e shows the transmission of content data from the scanning/initiating device to the advertising device via the BLE advertising and data channels;

FIG. 2a shows the basic structure of a BLE advertising channel packet;

FIG. 2b shows the basic structure of a BLE data channel packet;

FIG. 3a shows a new BLE advertising channel packet comprising audio payload data;

FIG. 3b shows a new BLE data channel packet comprising audio payload data;

FIG. 4 shows one example of how the advertising device may obtain audio data from the scanning/initiating device once a BLE connection has been established;

FIG. 5 shows one example of a system comprising a BLE-enabled scanning/initiating device and a BLE-enabled advertising device;

FIG. 6 shows the main steps of a method of using the system of FIG. 5; and

FIG. 7a computer-readable medium comprising a computer program configured to perform, control or enable one or more of the method steps of FIG. 6.

### DESCRIPTION OF SPECIFIC ASPECTS/EMBODIMENTS

Bluetooth™ was originally conceived with the aim of reducing the physical overhead of cabled connections and facilitating the ad-hoc connection of mobile battery-operated devices whose owners could not reasonably be expected to carry multiple cables and connectors about with them. It has since gained wide acceptance, particularly with users of mobile phones where elimination of physical cabling has spawned an industry devoted to the manufacture of associated peripherals. For mobile phone users, Bluetooth™ has also alleviated the burden of phone-to-phone and phone-to-computer file transfer.

One application of Bluetooth™ is the transmission of audio data between devices. For example, hands-free kits are currently used in vehicles to enable the drivers of said vehicles to participate in telephone calls without the need to hold their phones whilst driving. A hands-free kit typically comprises a Bluetooth™ headset having a microphone and one or more loudspeakers and is configured to communicate with the user's Bluetooth™-enabled mobile phone. The incoming audio signal is forwarded from the user's phone to the headset via a Bluetooth™ connection for playback on the loudspeakers. Similarly, when the user speaks into the microphone on the headset, an outgoing audio signal is generated by the headset and sent to the user's phone via the Bluetooth™ connection for transmission to the third party's phone.

Despite the above-mentioned benefits, Bluetooth™ has been found to be unsuitable for prolonged use with some battery-powered devices due to its associated power consumption. BLE has recently been developed to enable wireless connectivity with such energy-constrained devices but cannot be used to transmit audio data. Therefore, whilst Classic Bluetooth™ technology supports the use of hands-free headsets and the like, this feature is fundamentally absent from the BLE technology model.

The apparatus and methods disclosed herein may or may not address this issue.

BLE is a key feature of the Bluetooth™ 4.0 specification aimed at low-power applications for wireless devices within a 50 m range. This facilitates a wide range of applications and smaller form factor devices in the healthcare, fitness, security and home entertainment industries.

BLE is fundamentally different from Classic Bluetooth™ in that it is configured for short data bursts instead of periodic data streaming. In order to reduce power consumption, a BLE device remains in sleep mode until a communication event is triggered. BLE operates in the same 2.4 GHz ISM band as Classic Bluetooth™ but uses a different set of channels. Instead of Classic Bluetooth which uses 79 channels with a 1 MHz spacing, BLE uses 40 channels (37 data channels and 3 advertising channels) with a 2 MHz spacing. BLE also uses adaptive frequency hopping (AFH) to achieve a robust transmission in noisy RF environments, but in contrast to Classic Bluetooth™, remains on each channel for a longer period of time and relaxes the timing requirements.

A BLE device may operate in advertising, scanning or initiating modes depending on the required functionality. In advertising mode, the device periodically transmits advertising information (within one or more advertising channel packets) via one of the three advertising channels (37, 38 or 39) with a predefined interval between consecutive packets; in scanning mode, the device listens to an advertising channel for advertising information being transmitted by another device; and in initiating mode, the device sends a connection request to another device to establish a BLE connection with the other device.

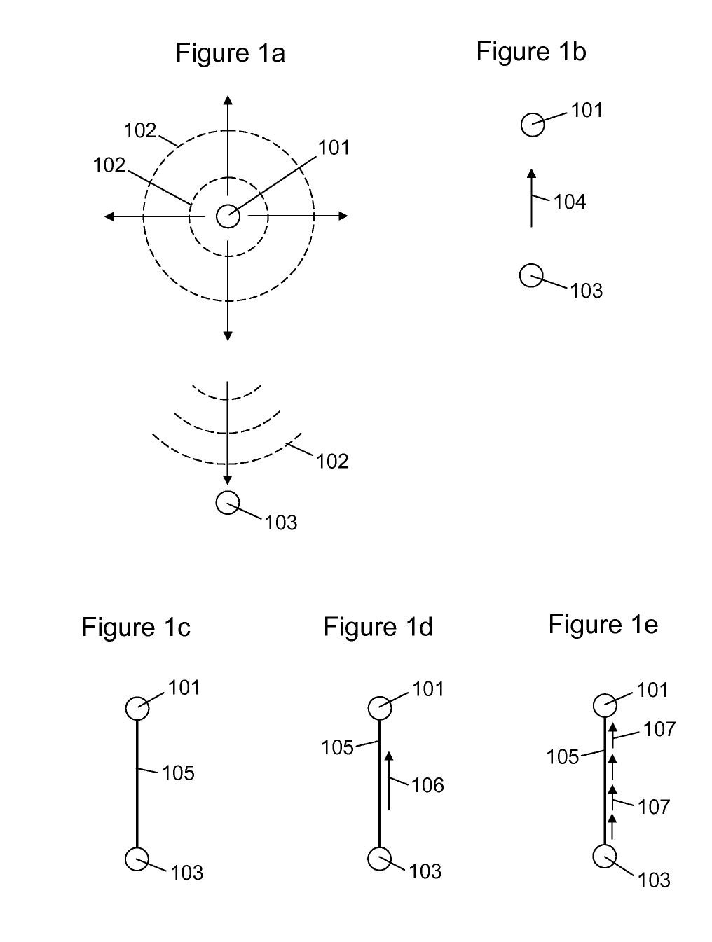

In order to establish a BLE connection between two devices, one device (the advertising device) must be in advertising mode and the other device (the scanning/initiating device) must be in initiating mode. This is illustrated in FIG. 1. As mentioned above, the advertising device 101 periodically transmits advertising channel packets 102 (FIG. 1a). In this example, the scanning/initiating device 103 is within range of these transmitted advertising channel packets 102. The scanning/initiating device 103 scans for a desirable advertising channel packet 102 and consequently sends a connection request 104 to the advertising device 101 (FIG. 1b). The advertising device 101 then accepts the connection request 104 and a BLE connection 105 is established (FIG. 1c).

Once the BLE connection 105 is established, the scanning/initiating device 103 adopts the role of a master device and the advertising device 101 becomes a slave device. To initiate the transfer of content data from the scanning/initiating device 103 to the advertising device 101, the scanning/initiating device 103 supplies the advertising device 101 with synchronisation data 106 (within one or more advertising channel packets) defining the channels and timing of the subsequent data exchange (FIG. 1d). The synchronisation data 106 defines two important parameters: connection interval and slave latency. The connection interval determines the time between the start of each data packet exchange sequence (the communication event), whilst latency specifies the number of connection intervals that the advertising device 101 may ignore without losing the BLE connection 105. The latter parameter gives the advertising device 101 an opportunity to optimise and preserve power consumption. Once the advertising 101 and scanning/initiating 103 devices are synchronised with one another, content data 107 (within one or more data channel packets) can be exchanged between the devices 101, 103 via the data channels (FIG. 1e). Each communication event is started by the transmission of content data 107 from the scanning/initiating device 103 and serves as an anchor point to calculate the time for the next communication event.

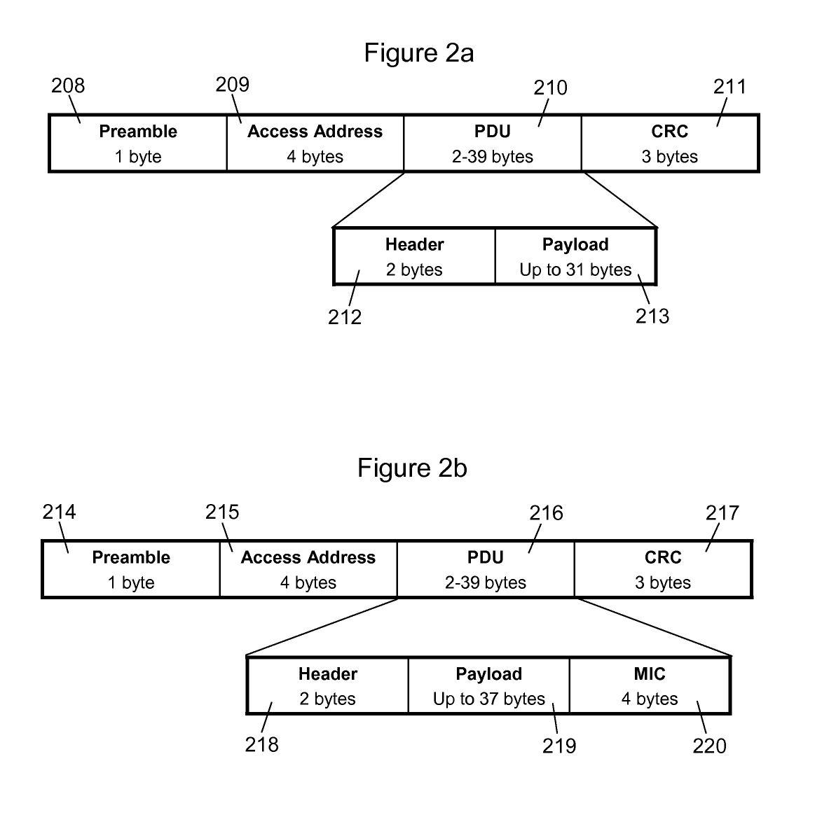

The general structure of BLE advertising and data channel packets is shown in FIGS. 2a and 2b, respectively. Both types of data packet comprise a 1 byte Preamble 208, 214, a 4 byte Access Address 209, 215 correlated with the channel number used, a Protocol Data Unit (PDU) 210, 216 of 2-39 bytes, and 3 bytes of Cyclic Redundancy Check (CRC) data 211, 217. The shortest and longest BLE data packets are therefore 80 and 376 bits, respectively. The Preamble 208, 214 indicates the start of the packet, the Access Address 209, 215 indicates the type of packet and the CRC data 211, 217 enables the Payload data 213, 219 (see below) to be checked for transmission errors.

The PDU 210 of an advertising channel packet comprises a 2 byte Header 212 and up to bytes of discovery information, connection establishment information and/or synchronisation data (Payload 213). The Header 212 indicates the configuration of the Payload 213. The PDU 216 of a data channel packet, on the other hand, comprises a 2 byte Header 218 and up to 37 bytes of Payload 219 trailed by 4 bytes of Message Integrity Check (MIC) data 220 (if the connection is encrypted). The Payload 219 contains the content data and any associated control information, whilst the MIC data 220 is used to identify any corruption of the Payload data 219.

As mentioned above, BLE is not currently configured to be used to transmit audio data. This prevents the use of BLE in hands-free headsets and the like. There will now be described a new BLE data packet which may provide a solution to this problem.

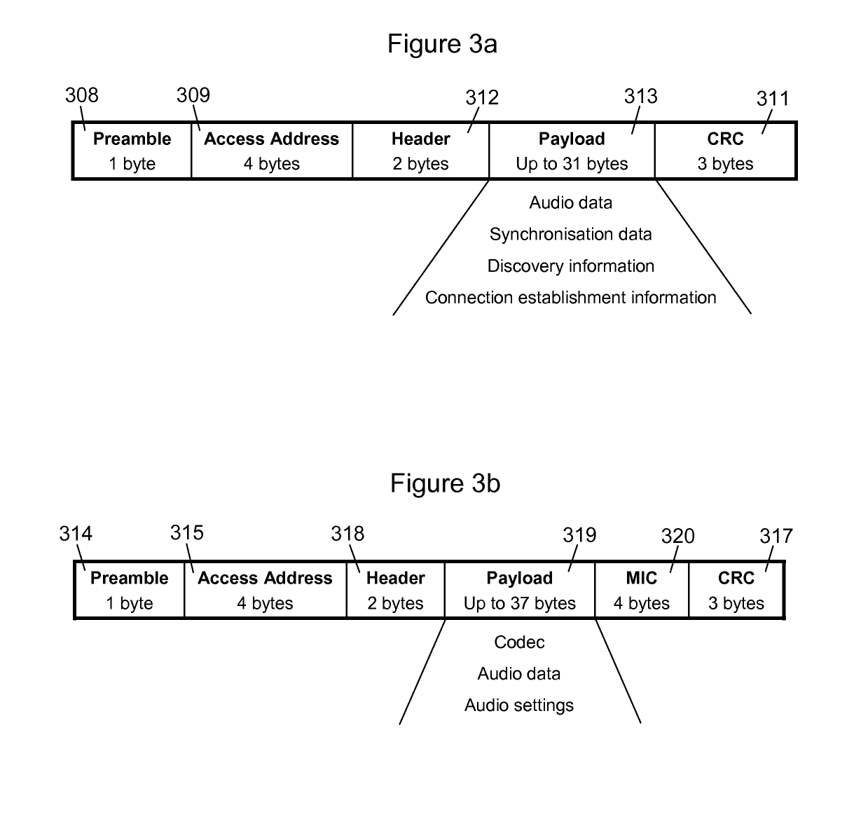

FIGS. 3a and 3b show new BLE advertising and data channel packets, respectively. Unlike existing BLE data packets, the advertising and data channel packets shown in FIG. 3 comprise audio payload data. In order to stream live audio data from one device to another (e.g. from a mobile phone to a hands-free headset during a telephone call), the communication medium must be able to support a data transfer rate of ˜16 kbps. Given that the maximum transfer rate of BLE is ˜300 kbps, BLE is more than capable of enabling live audio streaming.

The use of BLE for audio applications may allow Bluetooth™ headsets/earpieces to run on a single button cell battery (e.g. a zinc-air 100 mAh battery) for more than a year. It could also benefit other small battery-powered devices such as hearing aids (i.e. for the hard of hearing). Hearing aids are currently able to connect to a mobile phone for audio transmission via an inductive loop. However, the generation of magnetic fields to form the inductive loop is power intensive and unsuitable for prolonged use. BLE may offer a low-power alternative.

Once the BLE connection has been established between a mobile phone and a hearing aid (or earpiece, headset, etc) using customary techniques, the user could position his mobile phone in proximity to the audio source (e.g. another party) and transmit the audio signal received by his phone to his hearing aid using the BLE connection. If the mobile phone can be positioned such that the distance between the audio source and phone is smaller than the distance which could be conveniently established between the audio source and the hearing aid, the amplitude of the audio signal at the mobile phone will be greater than the amplitude of the audio signal at the hearing aid, thereby improving detection of the audio signal for subsequent receipt by the user. The controls of the mobile phone could also be used to adjust the volume (and/or other audio parameters) of the detected audio signal rather than having to use the hearing aid, which may allow the size, cost, complexity and/or power consumption of the hearing aid to be reduced. The parameters used to adjust the audio signal would therefore be conveniently transmitted using the BLE connection (in the data packet) to adjust the parameters at the hearing aid without having to operate on the hearing aid directly.

Different (or the same) data streams could also be sent to the left and right hearing aids/earpieces. Sending of different data streams may be useful if the user is more aurally impaired (temporarily (including due to a cold) or permanently) in one ear than the other ear, in which case the amplitude (volume) of the audio data set in one data stream could be greater than the amplitude (volume) of the audio data set in the other data stream. This aspect would require separate BLE connections to be made from the mobile phone to each hearing aid with different respective audio parameters being sent using the BLE connection. To avoid interference, each data stream would also need to be transmitted on different BLE channels.

Inclusion of audio data in the payload of BLE data packets could also be used to transmit recorded or live audio data to one or more pairs of Bluetooth™-enabled headphones. This could be used, for example, to provide tourist or historical information to the members of a tour group, either from the tour guide's microphone or from a storage device. A BLE connection could also be established between a mobile phone (say) and a network element (e.g. a network access point or network server) to obtain streamed audio data from the network element.

In order to enable the above-mentioned functionality, both devices would require the correct codec for encoding/decoding the audio data. In addition, the processor of each device would need to be configured to process the audio data. This may be achieved by installing the appropriate software and/or firmware onto the devices before use. Examples of suitable royalty free codecs include OPUS and EVS. Proprietary codecs which are specific to a particular device manufacturer or operating system could be used instead. Conveniently, the particular codec required for decoding the audio payload data could also be transmitted in the data packet to the receiving device (hearing aid, headset, etc).

The audio payload data could be provided in one or more advertising channel packets (FIG. 3a) and/or data channel packets (FIG. 3b). As shown in FIG. 3a, the Payload 313 of the advertising channel packet comprises the usual discovery information, connection establishment information and synchronisation data. However, in this example, the advertising channel packet also contains audio data as part of the Payload 313. The payload 319 of the data channel packet (FIG. 3b) comprises further audio data, and may also comprise an indication of the codec required for playback of the audio data and/or audio settings for controlling playback of the audio data. The codec identity tells the advertising device exactly which codec is required in order to decode the audio data (e.g. in case several codes have been installed on the advertising device), whilst the audio settings allow the advertising device to control the way in which the audio data is eventually output. For example, the audio settings may comprise volume settings to enable the advertising device to increase, decrease or mute the audio output.

Many existing Bluetooth™-enabled devices utilise Automatic Repeat Query (ARQ) to ensure that the transmitted packets are received by the other device. This technique is unsuitable for energy-constrained devices, however, because the acknowledgement and retransmission steps increase the power consumption of the devices considerably. To address this issue, the advertising device described herein may use Packet Loss Concealment (PLC) to mask the effects of packet loss. This technique is applicable in the present case because BLE data packets are smaller than Classic Bluetooth™ data packets. Therefore, any missing audio payload data has less of an impact on the overall sound quality than they would if Classic Bluetooth™ was used. The CRC data 311, 317 in the advertising or data channel packets may be used to identify the presence of missing audio payload data to facilitate PLC.

Thus, in certain embodiments, the apparatus can generate a single non-repeated Bluetooth™ Low Energy data packet for particular audio payload data. Accordingly, the system would not require/accept acknowledgement of receipt (e.g. ARQ) of data packets from a receiver and not retransmit the same audio payload data in subsequent data packets.

Further, in certain embodiments, if the apparatus generates a plurality of data packets with respective audio payload data for sequential portions of an audio stream for transmission via respective Bluetooth™ Low Energy advertising and/or data channels, the apparatus can be advantageously configured to generate respective Bluetooth™ Low Energy data packets with payload audio data of a particular size such that the non-receipt of the payload data of a particular packet for the audio stream can be concealed (e.g. using PLC) without substantial detriment to the user perception of the audio content for the audio stream. The sizes of the data packets/payloads discussed here would be appropriate for providing such an advantage.

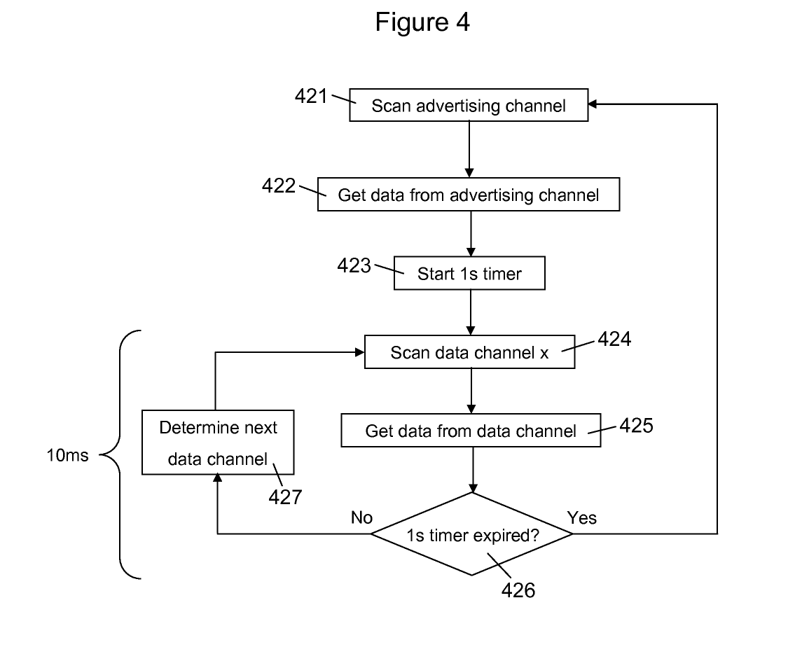

FIG. 4 illustrates one example of how the advertising device (e.g. a hearing aid) may obtain audio data from the scanning/initiating device (e.g. a mobile phone) once a BLE connection has been established. First, the scanning/initiating device encodes the audio data and generates a plurality of BLE data packets comprising respective audio payload data for sequential portions of an audio stream. The scanning/initiating device then modulates the advertising channel packets onto one of the three advertising channels to generate a transmission signal with a transmission burst interval of 1 s. The advertising device scans 421 the advertising channel, demodulates the signal and obtains 422 synchronisation data from the advertising channel packets. It then starts 423 a timer and scans 424 the first data channel for data channel packets to obtain 425 the audio payload data. The advertising device hops 427 from one channel to another (according to the synchronisation data received from the scanning/initiating device) every 10 ms (for example, other examples include any one of 11, 12, 13, 14, 15, 16, 17, 18, 19 or 20 ms, or multiples thereof) until 1 second (for example, other examples include 1.5 seconds, 2 seconds) has lapsed. If it has not received all of the audio payload data by this point, the advertising device then scans 421 the advertising channel once again for new synchronisation data and proceeds as before. This process continues until the entire audio stream has been transmitted by the scanning/initiating device, at which point the BLE connection is terminated.

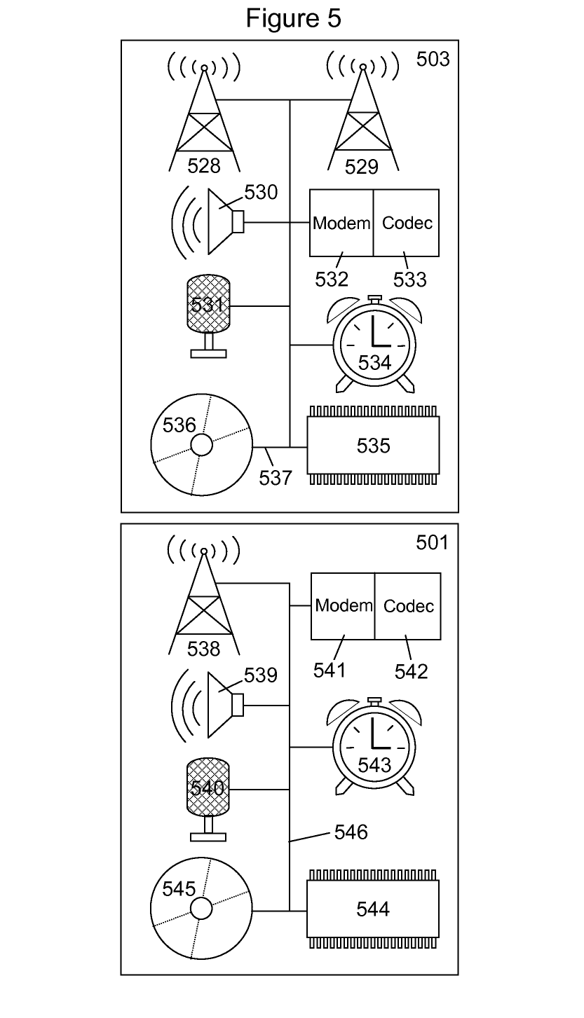

FIG. 5 shows a system comprising the scanning/initiating device/apparatus 503 and the advertising device/apparatus 501 according to one embodiment. The scanning/initiating device 503 may be one or more of an electronic device, a portable electronic device, a portable telecommunications device and a module for any of the aforementioned devices. The advertising device 501 may be one or more of an electronic device, a battery-powered device, an audio headset, a hearing aid, a battery-powered loudspeaker and a module for the same.

The scanning/initiating device 503 comprises a network transceiver 528, a BLE transceiver 529 (which may or may not be combined with the network transceiver 528), a loudspeaker 530, a microphone 531, a modem 532, a codec 533, a timer 534, a processor 535 and a storage medium 536, which are electrically connected to one another by a data bus 537.

The network transceiver 528 is configured to transmit telecommunication signals to, and receive telecommunication signals from, a remote device via a telecommunications network, whilst the BLE transceiver 529 is configured to transmit BLE signals to, and receive BLE signals from, the advertising device 501 via one or more BLE advertising and/or data channels. The BLE transceiver 529 may or may not be configured to transmit and receive Classic Bluetooth™ signals as well as the BLE signals (i.e. dual mode rather than single mode).

The loudspeaker 530 is configured to convert audio data received from a remote device via a telecommunications network into sound, and the microphone 531 is configured to convert sound into audio data for transmission to a remote device via a telecommunications network or to the advertising device 501 via the BLE channels.

The timer 534 is used to synchronise data exchange with the advertising device 501 by determining when a communication interval has lapsed. The modem 532 is configured to modulate outgoing telecommunication/BLE signals and demodulate incoming telecommunication/BLE signals, whilst the codec 533 is configured to encode outgoing telecommunication/BLE signals and decode incoming telecommunication/BLE signals. The codec 533 may comprise hardware, software and/or firmware.

The processor 535 is configured for general operation of the scanning/initiating device 503 by providing signalling to, and receiving signalling from, the other components to manage their operation. The storage medium 536 is configured to store computer code configured to perform, control or enable operation of the scanning/initiating device 503. The storage medium 536 may also be configured to store settings for the other components. The processor 535 may access the storage medium 536 to retrieve the component settings in order to manage the operation of the other components.

The storage medium 536 may be configured to store incoming audio data for later output. In this scenario, the storage may be permanent (e.g. stored as an mp3) or temporary (e.g. buffered audio). The processor 535 is also configured to generate BLE data packets comprising audio payload data for transmission to the advertising device 501, and may or may not be configured to generate Classic Bluetooth™ data packets as well as the BLE data packets (i.e. dual mode rather than single mode).

The processor 535 may be a microprocessor, including an Application Specific Integrated Circuit (ASIC). The storage medium 536 may be a temporary storage medium such as a volatile random access memory. On the other hand, the storage medium 536 may be a permanent storage medium such as a hard disk drive, a flash memory, or a non-volatile random access memory.

The advertising device 501 comprises a BLE transceiver 538, a loudspeaker 539, a microphone 540, a modem 541, a codec 542, a timer 543, a processor 544 and a storage medium 545, which are electrically connected to one another by a data bus 546. In certain embodiments, the device also includes a battery (not shown). Also, in certain embodiments, the advertising device 501 does not have a microphone 540 (e.g. in the case of a hearing aid).

The BLE transceiver 538 is configured to transmit BLE signals to, and receive BLE signals from, the scanning/initiating device 503 via one or more BLE advertising and/or data channels. The BLE transceiver 538 may or may not be configured to transmit and receive Classic Bluetooth™ signals as well as the BLE signals (i.e. dual mode rather than single mode).

The loudspeaker 539 is configured to convert audio data received from the scanning/initiating device 503 via the BLE channels into sound, and the microphone 540 (in embodiments with a microphone 540) is configured to convert sound into audio data for transmission to the scanning/initiating device 503 via the BLE channels.

The timer 543 is used to synchronise data exchange with the scanning/initiating device 503 by determining when a communication interval has lapsed. The modem 541 is configured to modulate outgoing BLE signals and demodulate incoming BLE signals, whilst the codec 542 is configured to encode outgoing BLE signals and decode incoming BLE signals. The codec 542 may comprise hardware, software and/or firmware.

The processor 544 is configured for general operation of the advertising device 501 by providing signalling to, and receiving signalling from, the other components to manage their operation. The storage medium 545 is configured to store computer code configured to perform, control or enable operation of the advertising device 501. The storage medium 545 may also be configured to store settings for the other components. The processor 544 may access the storage medium 545 to retrieve the component settings in order to manage the operation of the other components.

The storage medium 545 may be configured to store incoming audio data for later output. In this scenario, the storage may be permanent (e.g. stored as an mp3) or temporary (e.g. buffered audio). The processor 544 is also configured to generate BLE data packets comprising audio payload data for transmission to the scanning/initiating device 503, and may or may not be configured to generate Classic Bluetooth™ data packets as well as the BLE data packets (i.e. dual mode rather than single mode).

The processor 544 may be a microprocessor, including an Application Specific Integrated Circuit (ASIC). The storage medium 545 may be a temporary storage medium such as a volatile random access memory. On the other hand, the storage medium 545 may be a permanent storage medium such as a hard disk drive, a flash memory, or a non-volatile random access memory.

It should be noted that the terms “scanning/initiating device” and “advertising device” have been used in respect of apparatus 503 and apparatus 501 (respectively) for clarity purposes. In other embodiments, the apparatus 501 could be considered to be the scanning/initiating device and the apparatus 503 could be considered to be the advertising device 501. Thus, pairing could be initiated at either device.

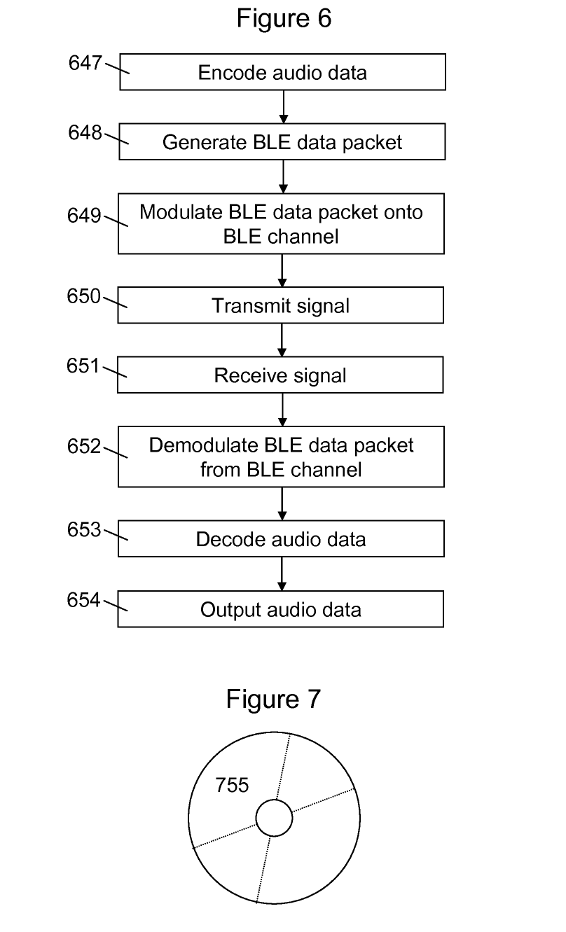

The main steps 647-654 of a method of using the above-mentioned system are illustrated schematically in FIG. 6. The scanning/initiating device 503 encodes 647 the audio data, generates 648 BLE data packets using the encoded audio data, modulates 649 the BLE data packets onto BLE channels to create a BLE signal, and transmits 650 the BLE signal to the advertising device 501. The advertising device 501 then receives 651 the BLE signal, demodulates 652 the BLE data packets from the BLE channels, decodes 653 the audio data, and finally outputs 654 the decoded audio data.

FIG. 7 illustrates schematically a computer/processor readable medium 755 providing a computer program according to one embodiment. In this example, the computer/processor readable medium 755 is a disc such as a digital versatile disc (DVD) or a compact disc (CD). In other embodiments, the computer/processor readable medium 755 may be any medium that has been programmed in such a way as to carry out an inventive function. The computer/processor readable medium 755 may be a removable memory device such as a memory stick or memory card (SD, mini SD or micro SD).

The computer program may comprise computer code configured to perform, control or enable one or more of the method steps 647-654 of FIG. 6. In this respect, the computer program may be stored on the storage medium 536 of the scanning/initiating device 503, the storage medium 545 of the advertising device 501 or the storage media 536, 545 of both devices 501, 503.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-32. (canceled)

33. An apparatus comprising at least one processor and at least one memory including computer program code, the at least one memory and the computer program code are configured to, with the at least one processor:
generate a Bluetooth™ Low Energy data packet comprising audio payload data;
wherein the apparatus is configured to generate the data packet to include an indication of a codec for playback of the audio payload data and/or audio settings for controlling playback of the audio payload data.

34. The apparatus of claim 33, wherein the apparatus is configured to generate the data packet to include Cyclic Redundancy Check data for the audio payload data to enable the audio payload data to be checked for transmission errors.

35. The apparatus of claim 33, wherein the audio settings comprise volume settings.

36. The apparatus of claim 33 wherein a Bluetooth™ Low Energy channel is at least one of a Bluetooth™ Low Energy advertising channel and a Bluetooth™ Low Energy data channel.

37. The apparatus of claim 33, wherein the apparatus is configured to generate the data packets to include at least one of an indication of a start of the audio stream, an indication of an end of the audio stream, and an indication of an order of the sequential portions of the audio stream.

38. The apparatus of claim 33, wherein the apparatus is configured to include in the data packet an indication of volume level.

39. An apparatus comprising at least one processor and at least one memory including computer program code, the at least one memory and the computer program code configured to, with the at least one processor:
decode a received Bluetooth™ Low Energy data packet wherein the data packet includes an indication of the codec needed to decode the data packet; and
generate an audio payload data for audio output.

40. The apparatus of claim 39, wherein the apparatus is configured to output the decoded audio output.

41. The apparatus of claim 39, wherein the apparatus is one or more of a battery-powered device, an earpiece, a headset, a hearing aid and a module for one or more of the same.

42. A method comprising generating a Bluetooth™ Low Energy data packet comprising audio payload data and an indication of the codec needed to decode the packet data stream.

43. The method of claim 42, further comprising modulating the Bluetooth™ Low Energy data packet onto a Bluetooth™ Low Energy channel to generate a transmission signal.

44. A method of claim 42, wherein the generated data packet contains an indication of volume level.

45. A method of claim 42, further comprising generating of a plurality of data packets with respective audio payload data for sequential portions of an audio stream for transmission via respective Bluetooth™ Low Energy data channels at a transmission bursts.

46. A method of claim 42 further comprising decoding another Bluetooth™ Low Energy data packet comprising audio data for audio output wherein the another data packets comprises an indication of volume level.

47. The method of claim 46, further comprising demodulating the another data packet from a Bluetooth™ Low Energy channel.

48. A non-transitory computer media that contains program code instructions that when executed by a processor cause a device to generate a Bluetooth™ Low Energy data packet stream that contains audio data and additionally an indication of which codec is needed to decode said data.
